(19) United States
(12) Patent Application Publication
(10) Pub. No.: US 2009/0048726 A1
(43) Pub. Date: Feb. 19, 2009

(54) Vessel performance monitoring system and method

(75) Inventor: Dean Allen Lofall, Poulsbo, WA (US)

Correspondence Address: Steven P Koda, PMB 159, 800 Sleater Kinney Road, Lacey, WA, 98503, US

(73) Assignee: Lofall Marine Systems, LLC, Poulsbo, WA (US)

(21) Appl. No.: 12/218,007

(22) Filed: Jul. 10, 2008

Related U.S. Application Data
(60) Provisional application No. 60/964,530, filed on Aug. 14, 2007.

(51) Int. Cl. G06F 17/00

(52) U.S. Cl. 701/21

(57) ABSTRACT

Vessel operating data is collected and stored while training a monitoring system. The training process includes navigating along a first path while running at a constant RPM for each of multiple RPM settings. The step is repeated for an opposite heading. Data from one or more training runs is used to derive models of estimated vessel performance. A calibration process may be performed to determine performance degradation due to marine growth and/or propeller damage. During real time operation, vessel performance is monitored and displayed. An operator may compare actual performance versus estimated performance in generally real time using the training data and real time data. The operator may change course or RPM to improve performance, such as to improve vessel miles per gallon.

### CROSS REFERENCE TO RELATED APPLICATIONS

This application claims the benefit of U.S. provisional application No. 60/964,530, filed Aug. 14, 2007.

### FIELD OF THE INVENTION

The present invention generally relates to monitoring and analysis of vessel performance, and more particularly to systems and methods for obtaining baseline and calibration vessel performance data for a given vessel and for analyzing vessel performance during real time operation.

### BACKGROUND OF THE INVENTION

It is desirable to monitor and improve vessel performance so as to optimize fuel economy, such as for yachts and other sea-going vessels. Fuel is the greatest operating cost of mechanically powered vessels. When time schedules are not the driving factor of selecting an operating state, it is prudent for the vessel operator to choose an operating state that provides the best fuel economy. Yachts and ships may operate in an underway operating state for several hours or days at a time.

Various factors, including external factors and intrinsic design factors, may impact the fuel economy of a vessel. External factors may include wind direction and speed and water current direction and speed. Understanding the real time effects of wind and currents on a vessel allows an operator to navigate the vessel in an optimum location on the water in relation to tidal flows, and to choose best engine operating speeds for a given situation. Speed over ground (SOG) may be measured using GPS navigation systems. When measured SOG deviates from expected speed through water (STW) determinations, the deviation represents the effects of tidal current and wind—and can be expressed in positive or negative nautical miles/hour or knots. When an operator can realize the real time effects of tidal current and wind at any time while operating the vessel, then timely decisions can be made to optimize the operating state or navigation through varying tidal flows.

An intrinsic design factor which impacts vessel performance is hull hydrodynamic resistance. Hull hydrodynamic resistance impacts fuel economy and speed in relation to engine operating RPM. Bringing a vessel up to hydroplaning speed is desirable for fuel economy. A difficult operating condition for the hull is to accelerate from displacement speed up to minimum planing speed. A great deal of power and fuel consumption is required to get “over the hump” and up on a plane, (e.g., hydroplane). There is increasing hydrodynamic resistance as the vessel tries to move from a displacement mode to the planing mode. When the hull reaches minimum planing speed, it comes completely up onto the surface of the water allowing the bow to drop to a level position. The engines then may throttled back to a degree without losing the plane. The effect of hydrodynamic resistance is not constant throughout the vessel operating RPM range, but may be modeled as described in the detailed description to derive operational performance deviation determinations.

Accordingly, there is a need for systems to monitor and analyze vessel performance. In particular, there is a need for systems and methods that model vessel performance based on external conditions and intrinsic design conditions. These and other needs are addressed by various embodiments of the present invention.

### SUMMARY OF THE INVENTION

The present invention provides a system and method of monitoring performance of a vessel. Real time monitoring provides an indication of actual performance versus estimated performance, such as of vessel fuel performance (e.g., miles per gallon). The operator may alter heading or engine RPM to improve performance. Estimated performance is derived using performance models. For example, empirical data is stored in a database and serve as the basis for estimated performance. In some embodiments a test may be performed including navigation of the vessel in a generally closed path to derive the vessel efficiency for its given propeller and hull conditions (e.g., performance degradation due to marine growth and/or propeller damage).

The empirical data for estimating vessel performance may be obtained by a training process in which the vessel or a like vessel is run through a process for training the vessel performance monitoring system. In particular the specific system specimen may be trained. In some embodiments data is obtained for a given vessel and a given performance monitoring product model and stored in memory.

The training process may include navigating along a first path while running at a constant RPM for each of multiple RPM settings. The step is repeated for an opposite heading. Data from one or more training runs is used to derive models of estimated vessel performance.

### BRIEF DESCRIPTION OF THE DRAWINGS

The invention is further described in the detailed description that follows, by reference to the noted drawings by way of non-limiting illustrative embodiments of the invention, in which like reference numerals represent similar parts throughout the drawings. As should be understood, however, the invention is not limited to the precise arrangements and instrumentalities shown. In the drawings:

FIG. 1 is a diagram of hull resistance to speed;

FIG. 2 is a diagram of a vessel performance monitoring and analysis system, in accordance with an embodiment of the present invention;

FIG. 3 is a flow chart of a method for training the vessel performance monitoring system in accordance with an embodiment of the present invention;

FIG. 4 is a flow chart of a method for obtaining empirical data for training vessel performance monitoring system in accordance with an embodiment of the present invention;

FIG. 5 is flow chart of a method for calibrating the vessel performance monitoring system, in accordance with an embodiment of the present invention;

FIG. 6 is flow chart of a method for monitoring real time vessel performance, in accordance with an embodiment of the present invention;

FIG. 7 is a graph of vessel speed in knots versus engine RPM; and

FIG. 8 is a graph of vessel miles per gallon versus engine RPM.

### DETAILED DESCRIPTION OF ILLUSTRATIVE EMBODIMENTS

In the following description, for purposes of explanation and not limitation, specific details are set forth, such as GPS systems, tachometers, computers, terminals, devices, components, software products and systems, operating systems, development interfaces, hardware, etc. in order to provide a thorough understanding of the present invention.

However, it will be apparent to one skilled in the art that the present invention may be practiced in other embodiments that depart from these specific details. Detailed descriptions of well-known networks, communication systems, computers, terminals, devices, components, techniques, data and network protocols, software products and systems, operating systems, development interfaces, and hardware are omitted so as not to obscure the description of the present invention.

According to various embodiments of the present invention, a training method is performed to obtain empirical data of vessel performance under various conditions for an engine operating range. Such data in turn may be used to derive a model of vessel performance. Thereafter, the vessel operator may obtain instantaneous vessel performance information and data to make better navigational and operating decisions. For example, real time performance monitoring methods may be performed to make the operator aware of: the instantaneous impact of external influences of wind and current on the boat's hull; nautical miles per gallon fuel consumption; and operational range. The operator then may make choices to navigate through specific tidal flows at optimum engine RPM so that the best fuel economy and the optimal speed over ground are achieved. Accordingly, both training methods and real-time performance monitoring methods are described herein. In addition, a calibration method may be performed to calculate a correction factor of vessel performance for given hull conditions, (e.g., to account for underwater marine growth).

Embodiments of the present invention use real-time measured data and compare it with the empirical data. The empirical data includes data obtained during the training phase of operation, (e.g., a period of time after the vessel has typically left a maintenance yard where the propellers are known to be in good working order and the hull is clean). Derived values from the empirical data may provide good indicators of speed through the water, impact of current and wind on the hull, fuel efficiency and degradation of hull and propeller performance due to damage or excessive marine growth.

One purpose of obtaining the empirical data is to generate a model of vessel performance. In effect the model accounts for hull hydrodynamic resistance over an operating range of the vessel. The effect of hydrodynamic resistance is not constant throughout the vessel operating RPM range. By collecting sample baseline recordings of vessel performance, the effects of hydrodynamic resistance can be modeled with a high degree of accuracy. This model may provide a basis to derive operational performance deviation determinations.

According to some embodiments of the invention, a calibration process may be performed to derive a correction factor to account for changes in vessel performance due to propeller damage or excessive marine growth on the vessel's hull. During the calibration process, data is collected while the vessel completes a generally closed path. Operating data is gathered during navigation of the path and used to derive an efficiency percentage of vessel performance. In an example embodiment, the result represents a percentage of optimum performance as compared to the empirical data established when the vessel's underside was clean and the propellers were in proper order. A number significantly less than 100% will represent to the operator that there are problems causing underperformance of the hull and/or propeller.

An advantage of embodiments of the present invention is real time performance monitoring may be achieved using minimal real time measurements obtained from accessible sources. One measurement is speed over ground (SOG), which may be obtained from the vessel's Global Positioning System's (GPS) serial output, (e.g., NMEA 183/2000 serial output). Another measurement is the vessel engine's revolutions per minute (RPM). Engine RPM may be measured in any of various ways. For example, engine RPM may be measured by a frequency counter using signals generated by the engine tachometer output (e.g., as provided by an engine control system). In another embodiment, the frequency counter may use the engine distributor points signal. In still another embodiment the engine RPM may be obtained using a measurement of the frequency component of the engine's alternator output divided by the pulley ratio and number of generator poles. In still another embodiment the engine RPM may be obtained using a measurement of the frequency component of a signal obtained from an eddy current (or proximity) probe sensing physical components of an engine rotating component, such as flywheel teeth, crankshaft pulley bolts or keyways.

Hull Hydrodynamic Resistance

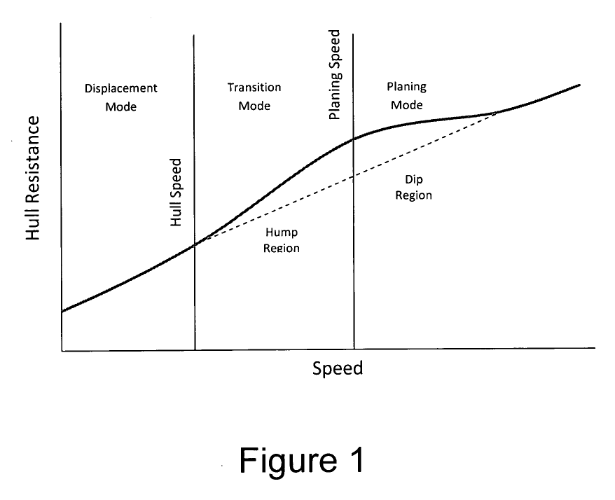

FIG. 1 shows an example speed to resistance curve which illustrates the increasing hydrodynamic resistance as a vessel tries to move from a displacement mode to a planing mode. A great deal of power and fuel consumption is required to get “over the hump” and up on a plane. In particular a difficult operating condition for the hull is to accelerate from a displacement speed up to minimum planning speed.

The upper speed of the displacement mode is the maximum obtainable displacement hull speed, which is characterized by Froude's formula of speed-to-length ratio. As a planing hull attempts to exceed this speed, it moves into the transition mode, or the hump region. In this speed range, it is neither operating in displacement mode nor in planing mode; it is literally climbing out of the water. In this semi-displacement-semi-planing speed range the bow will rise upward and the stern will squat. As the vessel operator continues to increase engine RPM, there won't be much speed improvement. Finally, when the hull reaches minimum planing speed, based on planing speed-to-length ratio, it lifts up on a plane. This ratio is expressed as a constant (typically around 2.5) multiplied by the square root of the waterline length, providing the speed in knots. When the hull reaches minimum planing speed, it comes completely up onto the surface of the water, the bow drops back to level and the engines can be throttled back somewhat without losing the plane.

In practice, after pushing the vessel “over the hump” and getting on a plane, there is a reduction in power requirements and also in fuel consumption. This “dip” below the curve roughly equals the area of the hump's increase above the curve. However, as speed continues to increase the original speed-to-power curve resumes its prior accelerated resistance and begins to climb geometrically again.

By modeling the non-linear relationship of hull resistance to engine RPM, the non-linear relationship can be measured and reliably repeated. In particular, while a hull remains in a constant condition without excessive marine growth or damage to the propulsion system, Speed Through the Water (STW) can be estimated with a high degree of accuracy.

When measured Speed Over Ground (SOG) readings deviate from expected speed through the water (STW) determinations, the deviation represent the effects of tidal current and wind and can be expressed in positive or negative nautical miles/hour or knots. When an operator can realize the real time effects of tidal current and wind at any time while operating the vessel, then timely decisions can be made to optimize the operating state or navigation through varying tidal flows.

### Vessel Performance Monitoring System

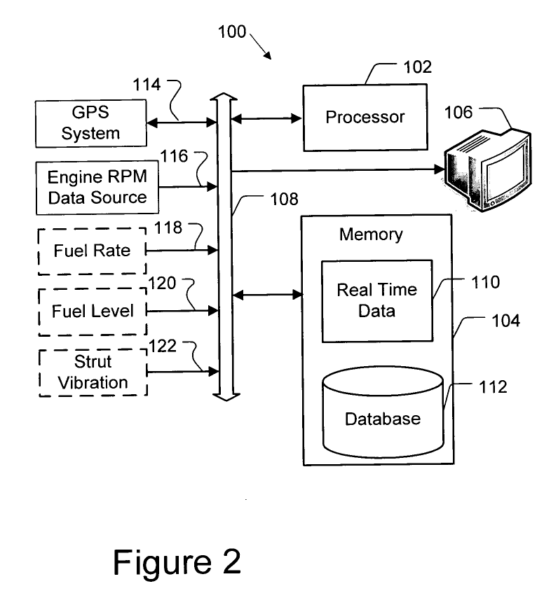

FIG. 2 shows a vessel performance monitoring system 100 according to an embodiment of the present invention. The monitoring system 100 includes a processor 102, memory 104 and a display 106, which may be implemented separately or together. For example, the various components may be implemented as a general purpose computer, an embedded computer, or the like. In some embodiments a bus 108 or other communication path or network path may carry signals among various components of the monitoring system 100. For example, an NMEA-2000 data network may be implemented. NMEA 2000 is a combined electrical and data specification for a marine data network for communication between marine electronic devices such as depth finders, nautical chart plotters, navigation instruments, engines, tank level sensors, and GPS receivers. It has been defined by, and is controlled by, the US based National Marine Electronics Association (NMEA). In some embodiments, an NMEA-183 serial bus standard also may be implemented.

The monitoring system 100 may receive inputs from various devices on the vessel. In a preferred embodiment a global positioning system (GPS) input 114 and an engine RPM input 116 are received. The engine RPM input 116 may be engine RPM or data from which engine RPM may be derived. Some vessels may include multiple engines. In such embodiments, the engine configuration also is tracked. If multiple engines are in operation, then the engine RPM of each engine may be input. In some embodiments, additional data may be input. For example, a signal indicative 118 of fuel rate may be received or derived. In some embodiments a signal 120 indicative of fuel level may be received or derived. Further, in some embodiments a signal 122 indicative of propulsion system vibration may be received or derived. The various inputs may be monitored and stored in memory 104 during training, calibration and real time operation.

The system is very sensitive to the level of marine growth below the waterline. This is a great benefit of the system. Without the vessel performance monitoring system and methods, it would be very difficult to know how much marine growth is underwater, because SOG, RPM and GPH are so dynamic and would be hard to understand underperformance without knowing exact current flow and expected speed for a given RPM. The system with provides an indication that performance is degrading, and excessive fuel is being consumed.

### Training Method

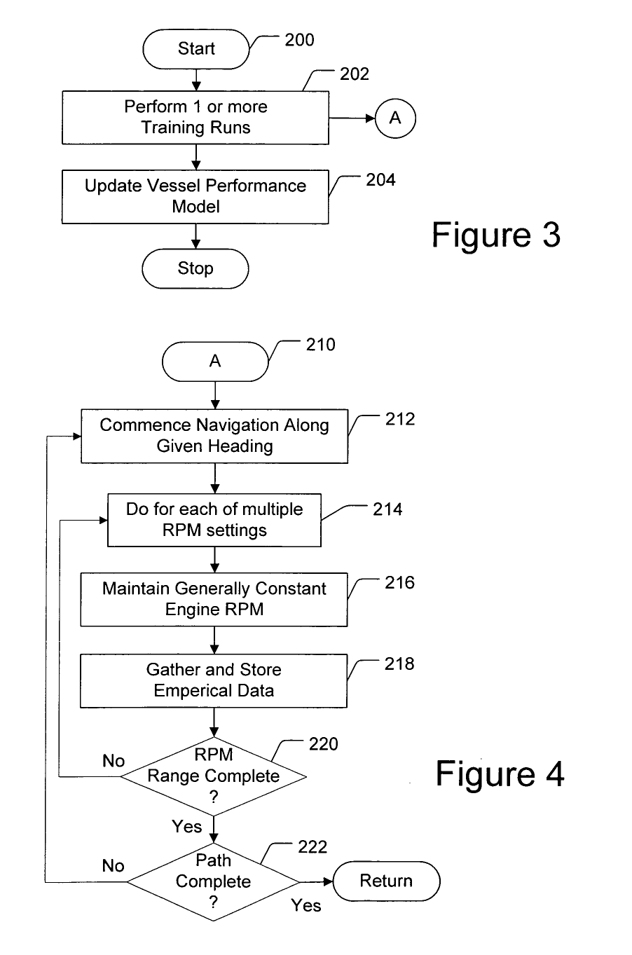

FIGS. 3 and 4 show flow charts of a process 200 for obtaining empirical data that may be used for training the vessel monitoring performance system. At step 202 of FIG. 3, one or more training runs are performed. FIG. 4 shows the process 210 performed for each training run. At step 212 the vessel commences navigation along a first heading. While on the heading empirical data is collected over a range of engine RPM (see step 214). At step 216 the engine RPM is set and maintained at a generally constant value for a given amount of time. For example, this value may be the idle speed for the vessel. At step 218, empirical data is gathered and stored while operating at that constant RPM. The RPM then is changed to a new setting and the steps 216 and 218 are repeated. In a given embodiment the steps 216, 218 may be repeated with the engine RPM being changed so as to obtain empirical data for each of several RPM settings between idle and maximum. For example, at step 220, the RPM range may be tested to determine whether empirical data has been collected for each of the engine RPM settings. If not, then data is collected for another RPM setting. When data has been collected for each setting, the process is repeated for another heading (see step 222). For example, the heading may be changed by 180 degrees and the steps 214-220 repeated for that new heading. Once the navigation path is complete, the training run is over. In some embodiments multiple training runs may be performed, such as by navigating along a first heading and its opposite heading for each of multiple unique headings. Although a given training run is described as having two parts, (e.g., one for a first heading and one for an opposite heading), in some embodiments, a navigation run may include, for example, four parts, (e.g., one at a first heading, one at each of 90, 180 and 270 degree differences from the first heading). Other configurations also may be performed.

An advantage of including headings of opposite direction is to cancel out the effects of wind and current. At least one training run is needed to develop a performance model. Multiple training runs allow for improved accuracy of the model. By maintaining a heading while gathering data at a given RPM minimal rudder angles are experienced during training. Collecting data over the RPM operating range of the vessel is desired to ensure data is not collected just after the engine was sped up but before the hull speed has become constant for that RPM. An advantage of maintaining a heading during each part of the training run is to prevent the subsequently derived model to be skewed by excessive data collection while running in one direction with the current or wind. Training runs typically are performed when the propeller is known to be in good working order and when the hull is free of marine growth, (e.g., shortly after the vessel has left a maintenance yard where the propellers are known to be in good working order and the hull is clean). The training (or commissioning) of the system need not be repeated, and may be performed only once. This is because vessel performance in relation to RPM has been found to be highly repeatable. If the bottom condition (level of marine growth) of the vessel remains good, and the weight of the vessel is relatively constant, the system accuracy is very reliable.

In some embodiments, the empirical data may be obtained while training one vessel and stored in a database that may be used by another vessel. For example, for vessels that are the same model, the manufacturer may include a common database of training data for each vessel.

### Calibration Method

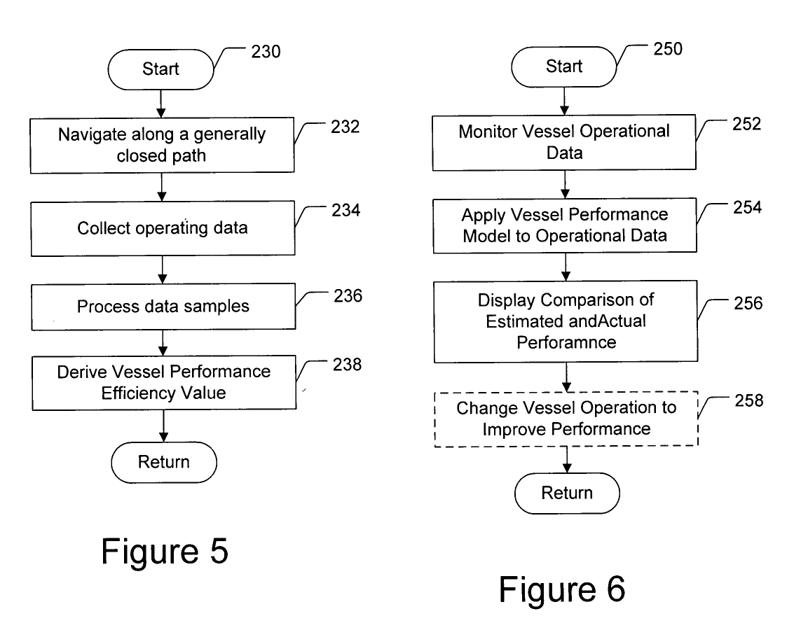

Long term monitoring provides the operator with information that will indicate whether there are hull performance problems caused by propeller damage or excessive marine growth on the hull. In some embodiments, a calibration method may be performed periodically. FIG. 5 shows a flow chart for a calibration method 230 according to an example embodiment of the present invention. At step 232, the vessel commences navigation along a generally closed path encompassing 360 degrees. In an example embodiment, the vessel may navigate in a circle. At step 234 operating data is collected. Samples of speed over ground (SOG) (measured), heading (HDG) (measured), and expected speed through water (ESTW) (derived) are taken at regular intervals, such as 1/sec. At step 236, the data samples are processed. For example, for each sample, SOG, ESTW are subtracted from one another to determine the instantaneous deviation. The sum of all (SOG-ESTW) deviation samples then may be added together. Also, for each sample HDG values are averaged together. When the average HDG readings equal 180, the test is complete. At step 238, the percentage efficiency is derived, such as from the following formula:

$$\% Efficiency = ( {\sum }_{k = 1}^{n} {( SOG \text{-} ESTW )}_{k} + ESTW ) / ESTW$$

The result represents a percentage of optimum performance as compared to the empirical data established during the training process—when the vessel's underside was clean and propellers were in proper order. A number significantly less than 100% will represent to the operator that there are problems causing underperformance of the hull and/or propeller.

### The Performance Analysis Model

During the training process, empirical data is logged and recorded to model the hull and propeller performance parameters. Values may include, for example, vessel speed over ground from GPS, engine RPM (average values together for twin engines) and fuel flow (add values together for twin engines). These values are recorded and averaged in various wind and current conditions to create a good model. It is the most ideal to record these values during slack current and no wind. However in the presence of current and wind, these values can be recorded in up-wind, down-wind, against-current and with-current runs, once averaged together an accurate profile will be established. More measurements will provide a better profile.

Empirical data stored in the system database is obtained from previously recorded relative readings of engine RPM and GPS speed over ground. This data may be recorded from dynamic inputs or logged by hand from visual observations of a GPS and helm tachometer display. Two elements are important to create an accurate performance profile; data must be recorded at many points through the engine operating RPM range, and data must be recorded while the vessel operates in calm weather conditions and while driving the vessel in the same and opposite directions of tidal flow. A curve-fit of all the varying data will in effect smooth the varying data values, and extract the effects of current and wind. This representative performance curve is used by the processor to compare real-time data with empirical data stored in the database to determine real-time relative performance and effects of tidal flow and wind on the vessel and present these data and results on a display unit for the purpose of observation by the vessel operator. Low performance or over-limit operating alarms may be determined by programming specific alarm rules into the processor software. When an alarm limit has been exceeded, an indication may be sent to the visual display unit. In addition to alarms, significant operating effect events may be presented in the form of an alert, such as when tidal flow has a negative effect on the operation of the vessel (running into a current) a display indication may be colored red, while a positive effect of tidal flow (running with the current) may presented in a green color on the display unit.

After training, the data from a wide range of RPM (underway idle through full power) it is used to produce the resulting speed and fuel consumption models. In particular, the empirical data obtained during training is used to develop empirical curves which serve as baselines for “Expected” data values. A baseline is subtracted from current (real-time) data values to produce deviation from an “Expected” baseline curve. Collection of empirical data is done by taking a snapshot of the operating values at each step of the training process and storing them in memory.

In an example embodiment the empirical data provides baseline curves of

Expected Hull Speed Through the Water at a given RPM in knots.

Expected Fuel Flow Rates in gallons per hour.

Expected Fuel Consumption in Nautical Miles Per Gallon.

Propeller Vibration in overall Inches Per Second.

The empirical data, for example, may be curve fit using a 6th order polynomial formula: y=b+c₁x+c₂x²30 c₃x³+c₄x⁴+c₅x⁵+c₆x⁶. The formula is evaluated in real-time to provide expected values for any of the items listed above for any given engine RPM.

In understanding the operational performance curve mathematically, we are able to apply our curve-fit formula to calculate any (speed, NMPG, GPH) amplitude value for a known engine RPM value.

With the dynamic inputs of engine RPM (Revolutions Per Minute) and GPS SOG (Speed Over Ground) applied to empirical data of Speed/RPM and GPH/RPM, deviations of expected performance of the vessel may be derived. Thus, the current/wind's influence on the vessel may be determined.

### Real Time Performance Monitoring Method

FIG. 6 shows a flow process 250 for monitoring real time vessel performance according to an example embodiment of the present invention. At step 252, operational data is monitored in real time during vessel operation. For example the following data may be obtained:

SOG: Speed Over Ground from a GPS device

RPM: Engine Revolutions Per Minute from engine tachometer output, distributor points signal, alternator output signal or engine control system
Port RPM: Port Engine RPM
Stbd RPM: Starboard Engine RPM
Avg RPM: Average Port and Starboard Engine RPM, if twin engine installation

HDG: Vessel True Heading from a GPS device

At step 254, the performance model polynomials are derived. For example the following models may be derived:

EGPH: Expected Gallons Per Hour, or relative measurements of fuel flow GPH @ RPM (total GPH of both engines for twin engine vessel)

ESTW: Expected Speed Through the Water, or relative measurements of SOG @ RPM in varying tidal flow and wind conditions.

At step 256, performance results are displayed, such as the following:
RPM: Engine RPM (Port RPM and Starboard RPM if twin engine vessel)
SOG: Speed Over Ground
EGPH: Expected fuel flow in Gallon Per Hour
ESTW: Expected Speed Through the Water
ICURR: Implied Current (SOG-ESTW)
NMPG: Expected Nautical Miles Per Gallon (ESTW/EGPH)
CNMPG: Corrected Nautical Miles Per Gallon (SOG/EGPH)

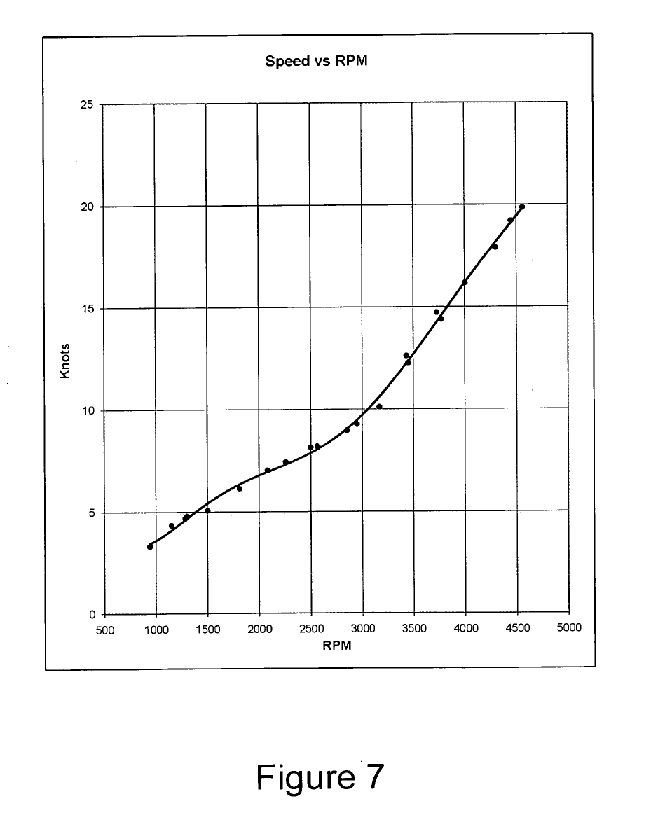

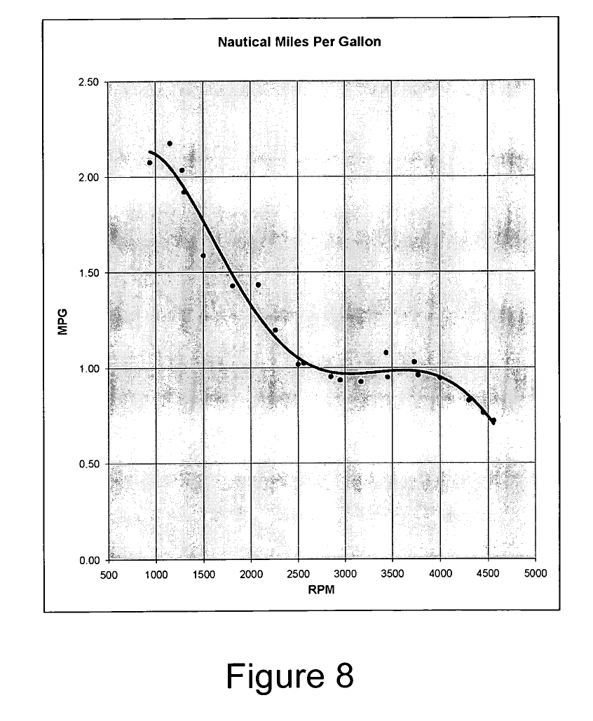

FIG. 7 shows an example graphical output of vessel speed in knots versus engine RPM. FIG. 8 shows an example graphical output of fuel miles per gallon versus engine RPM.

In some embodiments alarm indication may be displayed, as appropriate. For example, alarm limits may be triggered to warn the operator of:
Excessive negative effects of current on boat speed
Excessive fuel consumption per mile

Referring again to FIG. 6, the vessel operator, at the operator's discretion, may alter vessel operation to improve performance. For example, the operator may change the RPM or heading to improve the fuel miles per gallon performance.

Table 1 below lists the data derivations performed in a specific embodiment. (See Glossary at the end of detailed description for meanings of the abbreviations).

TABLE 1
Data Derivations

| | | | | FUEL | |
|---|---|---|---|---|---|
| | RPM | SOG | FGPH | LEVEL | VIB |
| FGPH | | NMPG | | RNG | |
| dbESTW | ESTW | Δ SOG- | | ERNG | |
| | | ESTW | | | |
| | | % PERF | | | |
| dbEGPH | EGPH | Δ | Δ FGPH- | GALS | |
| | ENMPG | ENMPG- | EGPH | REMAIN | |
| | | NMPG | % ENG | ERNG | |
| | | | EFFIC | Δ RNG- | |
| | | | PERF | ERNG | |
| | | | SEV/ | | |
| | | | DIAG | | |
| dbVIB | EVIB | | | | Δ VIB-EVIB |
| | | | | | VIB |
| | | | | | SEV/DIAG |

Table 2 below lists the data sources for a specific embodiment.

TABLE 2
Data Sources

| | | | Serial | |
|---|---|---|---|---|
| | Network | Serial | Data Acquisition | Hand |
| | NMEA 2000 | NMEA 183 | Devices | Enter |
| RPM | ✓ | ✓ | ✓₂ | |
| SOG | ✓ | ✓ | | |
| FGPH | ✓ | ✓ | | ✓₁ |
| FUEL LEVEL | ✓ | ✓ | | |
| VIB | | | ✓₃ | |

₁to determine ENMPG, EFGPH as baseline.
₂with frequency input from alternator, distributor or proximity probe
₃4-20 mA velocity sensor 10 Hz-1 KHz frequency range

### Glossary of Terms:

% PERF: Performance of the vessel presented as a percentage of baseline. This is determined through the circle test where influences of wind and tidal current are eliminated. The performance value is stored and can be viewed as a trend plot over time.

% ENG EFFIC: Engine operating efficiency expressed in percentage of baseline. The engine efficiency is determined by comparing current fuel consumption as compared to expected fuel consumption as determined by empirical data.

dbEGPH: Data Model that represents Expected Gallons Per Hour fuel flow rates for the complete range of engine RPM. This model is constructed of array data that is smoothed by a 6th order polynomial formula

dbESTW: Data Model that represents Expected Speed Through the Water for the complete range of operating engine RPM. This model is constructed of array data that is smoothed by a 6th order polynomial formula.

dbVIB: Data Model that represents Expected Vibration for the complete range of operating engine RPM. This model is constructed of array data that is smoothed by a 6th order polynomial formula.

EGPH: Expected Gallons Per Hour fuel flow rate for a given engine RPM, determined in real-time.

ENMPG: Expected Nautical Miles Per Gallon for a given engine RPM, determined in real-time.

ERNG: Expected Range of vessel expressed in nautical miles for a given engine RPM, as determined in real-time.

ESTW: Expected speed through the water for a given engine RPM, determined in real-time.

EVIB: Expected vibration amplitude for a given engine RPM, determined in real-time.

FGPH: Rate of fuel consumed by engines measured in Gallons Per Hour.

FUEL LEVEL: Level of the fuel tanks. The level is used to determine gallons remaining in the tank.

GALS REMAIN: Fuel Gallons Remain. This is determined by measuring the fuel level and deriving the number of gallons the remaining fuel represents.

GPS: Global Positioning System that provides both position and navigational information.

NMEA 183: National Marine Electronic Association serial data protocol specification, NMEA-0183. This is the legacy protocol of marine electronics and the predecessor of NMEA-2000.

NMEA 2000: National Marine Electronic Association CAN-network data protocol specification, NMEA-2000. This is the current protocol of marine electronics preceded by the NMEA-0183 serial data protocol.

NMPG: Rate of fuel consumed by engines over distance, measured in Nautical Miles Per Gallon.

NuDAM: Data acquisition devices that measures frequency or voltage for direct input into the onboard computer.

PERF SEV: Performance degradation severity ratings based on % PERF. OK, MODERATE, SERIOUS, EXTREME. OK: 100-95%, MODERATE: 95-90%, SERIOUS: 90-85%, EXTREME, less than 85%.

RNG: Operational Range of vessel expressed in nautical miles.

RPM: Engine Revolutions Per Minute.

SOG: Speed Over Ground as measured in real-time from the vessel's GPS

VIB: Vibration as measured by system represented in velocity RMS amplitude detection from 10 Hz to 1 kHz per ISO 2954-1975 (E).

VIB SEV: Vibration severity ratings. OK, MODERATE, SERIOUS, EXTREME. These severities are based on ISO-2954-1975 overall data and exceedances of baseline—OK: less than 200%, MODERATE: 200-400%, SERIOUS: 400-800%, EXTREME over 800% (percentage of baseline)

Δ ENMPG-NMPG: The difference of real-time Nautical Miles Per Gallon and Expected Nautical Miles Per Gallon. This value represents the amount of mileage lost due to less than optimum performance.

Δ FGPH-EGPH: The difference of Fuel Rate Gallons Per Hour and Expected Fuel Rate Gallons Per Hour. This value represents the amount of gallons per hour lost due to less than optimum performance.

Δ RNG-ERNG: The difference of Range and Expected Range. This value represents the amount of miles lost due to less than optimum performance.

Δ SOG-ESTW: The difference of measured Speed Over Ground and Expected Speed Through the Water. This value represents effects of wind and current on the hull and/or excess drag caused by underwater marine growth.

Δ VIB-EVIB: The difference of strut measured Vibration and Expected Vibration. High values represent problems with the propeller, bent shaft or strut bearing problems.

It is to be understood that the foregoing illustrative embodiments have been provided merely for the purpose of explanation and are in no way to be construed as limiting of the invention. Words used herein are words of description and illustration, rather than words of limitation. In addition, the advantages and objectives described herein may not be realized by each and every embodiment practicing the present invention. Further, although the invention has been described herein with reference to particular structure, materials and/or embodiments, the invention is not intended to be limited to the particulars disclosed herein. Rather, the invention extends to all functionally equivalent structures, methods and uses, such as are within the scope of the appended claims. Those skilled in the art, having the benefit of the teachings of this specification, may affect numerous modifications thereto and changes may be made without departing from the scope and spirit of the invention.

What is claimed is:

1. A real-time performance monitoring system for a vessel, comprising:
a display unit;
a processor for executing instructions;
a database of empirical operating data, including GPS Speed-Over-Ground (SOG) data in relation to a range of engine rotational rate data in various current and wind conditions;
a GPS input from a Global Positioning System (GPS) receiver; and
an engine rotational rate input.

2. The system of claim 1, wherein the empirical operating data comprises data obtained during a system training mode in which either one of the vessel or another vessel comparable to the vessel is navigated along a generally closed navigation path encompassing 360 degrees of direction.

3. The system of claim 2, wherein the empirical operating data further comprises historical performance data obtained during real time operation of the vessel.

4. The system of claim 1, further comprising instructions executed by the processor for averaging the empirical operating data over an engine operating range to produce typical operating characteristics of the vessel for given engine rotational rate frequencies.

5. The system of claim 1, wherein the database comprises GPS Speed-Over-Ground (SOG) data and fuel consumption rate in relation to a range of engine rotational rate data in various current and wind conditions.

6. The system of claim 1, further comprising an input of propulsion system vibration, wherein the database comprises GPS Speed-Over-Ground (SOG) data, fuel consumption rate, and propulsion system vibration in relation to a range of engine rotational rate data in various current and wind conditions.

7. The system of claim 5, further comprising instructions executed by the processor for averaging the empirical operating data over an engine operating range to produce typical operating characteristics of the vessel for given engine rotational rate frequencies.

8. The system of claim 6, further comprising instructions executed by the processor for averaging the empirical operating data over an engine operating range to produce typical operating characteristics of the vessel for given engine rotational rate frequencies.

9. The system of claim 1, further comprising instructions executed by the processor for comparing the GPS receiver input and the engine rotational rate input with select data from the database to determine real-time deviation of expected performance.

10. The system of claim 5, further comprising instructions executed by the processor for comparing the GPS receiver input and the engine rotational rate input with select data from the database to determine real-time deviation of expected performance.

11. The system of claim 6, further comprising instructions executed by the processor for comparing the GPS receiver input and the engine rotational rate input with select data from the database to determine real-time deviation of expected performance.

12. The system of claim 1 further comprising instructions executed by the processor for comparing the GPS receiver input and the engine rotational rate input with select data from the database to determine the effects of current and wind on vessel fuel consumption.

13. A method of monitoring performance of a vessel, comprising the steps:
monitoring vessel operational data in real time;
accessing a database of empirical operating data;
generating an operating curve from a subset of the empirical operating data, wherein the subset is selected based upon the real time monitored data; and
comparing the real time monitored data with a performance predicted by the generated operating curve.

14. The method of claim 13, further comprising:
obtaining first empirical operating data while operating the vessel at a constant engine rotational frequency and navigating the vessel along a common heading;
repeating the step of obtaining first empirical data for each of multiple engine rotational frequencies;
obtaining second empirical operating data while operating the vessel at a constant engine rotational frequency and navigating the vessel along a heading opposite to the common heading;
repeating the step of obtaining second empirical data for each of multiple engine rotational frequencies; and
storing the first empirical data and second empirical data in a database.

15. The method of claim 14, further comprising:
monitoring real time operating performance of the vessel; and
deriving an expected performance for the vessel from the database.

16. The method of claim 15, further comprising:
displaying a comparison of expected performance and actual performance.

17. The method of claim 15, further comprising the step of adjusting either one or both of vessel navigation path and vessel engine rotational rate to improve vessel fuel efficiency.

18. The method of claim 13 wherein the step of monitoring comprises: obtaining GPS Speed-Over-Ground (SOG) data.

19. The method of claim 18, wherein the step of monitoring further comprises obtaining fuel consumption rate data.

20. The method of claim 19, wherein the step of monitoring further comprises obtaining propulsion system vibration data.

21. The method of claim 13, further comprising:
deriving speed through the water; and
displaying data representing real-time expected fuel consumption and corrected fuel consumption based on derived speed through the water.

22. The method of claim 13, further comprising:
navigating the vessel along a generally closed path;
obtaining operating data during the navigating;
processing obtained data to determine efficiency of vessel performance.
